(19) United States
(12) Patent Application Publication
(10) Pub. No.: US 2016/0029656 A1
(43) Pub. Date: Feb. 4, 2016

(54) PROCESS FOR PREPARING A CONFECTIONERY, AND CONFECTIONERIES THUS OBTAINED

(71) Applicant: ROQUETTE FRERES, Lestrem (FR)

(72) Inventors: YOSHITAKA OKUBO, NODA CITY, CHIBA (JP); QINGLI WANG, SHANGHAI (CN); PING JIANG, SHANGHAI (CN)

(21) Appl. No.: 14/776,981

(22) PCT Filed: Mar. 14, 2014
(86) PCT No.: PCT/EP2014/055069

§ 371 Date: Sep. 15, 2015

(30) Foreign Application Priority Data
Mar. 15, 2013 (CN) 201310084390.0

(51) Int. Cl. A23G 3/38; A23G 3/40; A23G 3/34

(52) U.S. Cl. CPC A23G 3/38; A23G 3/0063; A23G 3/343; A23G 3/40; A23V 2002/00

(57) ABSTRACT

The present invention relates generally to a confectionery. More specifically, the present invention relates to a novel process for preparing novel sugar-free confectioneries having a gelled centre and a multilayer coating of laminated type. The present invention also relates to the confectioneries obtained by performing the process.

### FIELD OF THE INVENTION

The present invention relates generally to a confectionery. More specifically, the present invention relates to a novel process for preparing novel sugar-free confectioneries having a gelled centre and a multilayer coating of laminated type. The present invention also relates to the confectioneries obtained by performing the process.

### TECHNOLOGICAL BACKGROUND

For a long time, sweets or confectionery products were among the expensive pleasures reserved for special occasions. The sweets displayed in sweet shops remained for a long time a luxury food item intended for the well-off. Gradually, soft caramels, fruit pastes, pastilles, aerated confectioneries, marzipan and grilled almonds appeared on the market. Up to the end of the 19th century, confectionery products were manufactured in cottage-industry workshops. It was not until after that time that cooking, kneading, chopping and conditioning machines were developed and that industrial production was adopted. Sugar gradually lost its status as a luxury food item and became democratized. Confectionery products are now omnipresent in all industrialized countries.

The main categories of products are, inter alia, cooked sugar sweets, soft sweets, sweet-coated products, tablets, pastilles, chewing gums, gum-based sweets, liquorice-based confectioneries, fondants, aerated confectioneries (for example marshmallows), nougatine, fizzy powder and also products based on sugar, almonds or nuts (for example marzipan, nougats, etc.).

Confectioneries belong to a food family that has a large diversity of textures, forms, colours and flavours capable of seducing a wide variety of people. They almost all have in common the more or less extensive cooking of sugars and/or sugar substitutes mixed with other ingredients that give them their appeal and their taste and organoleptic characteristics. Many textures are available, arising from technologies specific to the various families of articles. Thus, cooked sugars have a glassy texture by virtue of high cooking temperatures and a low residual moisture content. Conversely, other confectioneries such as jellies benefit from a soft texture obtained by gelation and a higher moisture content. Yet other products, such as sweet-coated products, are manufactured by drum-coating in order to coat a centre with a crunchy layer of sugar and/or sugar substitutes. By means of these few examples, the full breadth of the processes that are available to a confectioner for producing these well-known sweet delicacies may quickly be appreciated.

The confectionery market has stagnated for about the last 10 years. This levelling-off of sales appears to be linked to increasing consumer health concerns: concern for a more balanced diet and the prevention of obesity and tooth decay among children are all factors that are curbing the purchase of confectioneries. To stimulate sales, industrialists have multiplied the novelties with amusing forms and presentations, surprising colours and tastes, and also with the appearance of “sugar-free” confectioneries that free consumers of guilt.

Thus, industrialists are continually in search of novel types of confectioneries that satisfy consumers' expectations, in terms of organoleptic parameters (search for a novel texture, novel taste, etc.) and also nutritional parameters (little or no sugar, good for the teeth, etc.).

### SUMMARY OF THE INVENTION

In the light of this observation, and after extensive research studies, the Applicant Company has, to its credit, succeeded in satisfying all the demanded requirements, and has found a novel process for manufacturing confectioneries that makes it possible to obtain novel confectioneries with a quite particular texture that has hitherto never been described in the prior art.

Furthermore, the manufacturing process is a truly outstanding technical feat since it makes it possible to alternate various types of coating layers around an edible centre. More particularly, the said manufacturing process allows the succession of a coating layer produced in an aqueous phase with a coating layer produced in an oil phase, and in doing so several times in a row, so as to obtain a type of laminated structure having a certain amount of crunchiness around an edible centre.

The invention concerns a new process for preparing a confectionery consisting in creating around an edible centre a succession of at least two coating layers by alternating an aqueous layer and an oily layer, characterized in that it comprises at least one step of hard coating using a coating syrup and one step of “fatty” or “oily” coating using fat and/or melted fat. Moreover, this new process is characterized in that it the hard coating step is a step of sugar-free hard coating.

This new process is also characterized in that the hard coating step for creating a hard coating on the surface of a centre comprises between 5 and 30 successive cycles, each cycle consisting of a phase of spraying a coating syrup, a phase of distributing the said syrup and a drying phase. Furthermore, the coating syrup used in this new process, contains polyols chosen especially from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM) and alpha-D-glucopyranosyl-1,1-sorbitol (=1,1-GPS), and mixtures thereof. Furthermore, the polyol contains in the coating syrup is predominantly maltitol.

This new process has also the characteristic that the polyol syrup used in the hard coating phase is a syrup composed, relative to its content of soluble solids, of at least 80% by weight of a polyol.

The process is also characterized in that the fatty coating step comprises between 1 and 5 successive cycles, each cycle consisting of a phase of spraying an oil or a melted fat onto the surface of the centres, a phase of distributing the oil or the melted fat and a hardening phase. The oil or the melted fat intended for the fatty coating is chosen from melted cocoa butter, cocoa liquor, condensed milk, hydrogenated vegetable oils, hydrogenated palm seed oil, lauric oil, palm oil, soybean oil, cottonseed oil, linseed oil, coconut oil and any other vegetable oil that may be used in food, artificial butter, animal fats (butter, lard, . . . ), and also all mixtures of one or more of these oils and/or melted fats. In a preferred embodiment, the oil or melted fat belongs to the category of CBS (cocoa butter substitutes).

The present invention concerns a process for creating a hard laminated coating on the surface of a centre, and comprising a plurality of cycles each comprising the following steps:
(a) an optional precoating step also known as a gumming step,
(b) a hard coating step comprising a first step of applying a coating syrup containing at least one polyol, the said polyol being obtained by catalytic hydrogenation of simple reducing sugars thus having a DP equal to 1, but also more complex reducing sugars composed of higher homologues with a DP greater than or equal to 2 of these simple sugars, such as disaccharides, oligosaccharides and polysaccharides and also mixtures thereof, and the said coating syrup having a solids content of between 60% and 90% by weight and preferably between 70% and 85% by weight, and even more preferentially greater than or equal to 72% and less than 80%; a second step for uniformly distributing this syrup on the surface of the products (pause time or rotary phase), and a third and final step of drying comprising the use of air at a temperature of between 40° C. and 80° C., for a time of at least 1 minute and of not more than 5 minutes;
(c) a step of coating in an oil phase comprising a step of applying an oil or a melted fat performed by spraying a liquid oil or a melted fat onto the surface of the centres, followed by a pause time or rotary phase for uniformly distributing the oil or the melted fat onto the surface of the centres, and completed with a drying step for fully hardening or congealing the oil of the melted fat layer before applying the following layer;
(d) an optional step of dusting with a polyol powder, also known as a filler.

In a preferred embodiment, this process is characterized by the succession of steps a, b, c, b, c and b, as previously described.

In a other preferred embodiment, this process is characterized in that the final step is a step of hard coating.

The Applicant has therefore, to its credit, discovered a novel process for manufacturing a novel type of confectionery, combining both the principles of soft or hard sweet coating and those of oil coating. The said process is characterized by the alternation around an edible centre of a layer (which may be hard or soft) obtained via a “standard” coating process with a layer obtained via a coating process with an oil phase. The alternation of these various types of layers may be simple or multiple, i.e. multilayers. Besides the novel and inventive nature of the said process and the confectioneries thus obtained by performing this process, the Applicant has also, to its credit, been able to produce such a process for alternating standard coating layers and oily layers. In point of fact, it did not appear obvious to be able to attach, stably and uniformly, an oil phase onto a surface obtained via a standard coating process using a coating syrup prepared in an aqueous phase.

What did not at all appear obvious either, and it is this that the Applicant has succeeded in overcoming, is the alternation and succession of aqueous layers and fatty layers, several times, in order to obtain a novel, creamy laminated texture, while at the same time also maintaining a crunchy aspect imparted by the standard coating layer.

The present invention also relates to a novel confectionery obtained by performing the novel process described above. The said confectionery is characterized by an entirely novel texture that is different from the textures usually encountered in confectioneries sweet-coated according to a standard process that is well known to those skilled in the art.

These confectioneries are characterized in that they consist of an edible centre coated with a succession of layers obtained by the alternation of hard coating and oily coating steps. Moreover, these confectioneries are characterized in that the centre is chosen from confectioneries, chewing gums, bubble gums, tablets, lozenges, gelled articles, fruit jellies, chewing pastes, boiled sweets, chocolate-flavoured products, nuts such as almonds, hazelnuts or peanuts, pharmaceutical or veterinary products such as pills, tablets, animal products, dietary products such as plant granules, additives based on enzymes or microorganisms such as yeasts, detergent lozenges, vitamins, flavourings, fragrances, acids, sweeteners or various active principles.

### DETAILED DESCRIPTION OF THE EMBODIMENTS

The present invention relates to a novel process for preparing a confectionery, characterized in that it consists in creating around an edible centre a succession of at least two coating layers by alternating an aqueous layer and an oily layer.

In the present invention, the term “aqueous layer” means a coating layer made using a syrup containing water, and the term “fatty layer” means a coating layer made using an oil or a melted fat.

In the present invention, the terms “fatty layer” or “oily layer” and “fatty coating” or “oily coating” are used indiscriminately, and mean the same thing: a coating made with an oil or a melted fat.

In the present invention, the term “melted fat” is used for fat or oil with low solidification point (i.e. below or close to room temperature, and around 25° C.). When these kind of melted fats are heated to temperature higher than their solidification point, they will transfer to liquid phase, but when the temperature decreases to its solidification point, they will transfer back to a solid phase.

That characteristic allows the oil/fat to form solid oil phase layers to separate polyol hard coating layers in the process of the present invention, as disclosed hereafter.

The novel preparation process is such that it comprises at least one “standard” coating phase, i.e. one step of hard coating and one step of “fatty” or “oily” coating.

According to one particular embodiment, the coating step may also be a “soft” coating step.

According to a particular embodiment of the invention, the said coating process is characterized in that the standard hard coating step is a step of sugar-free hard coating.

The tendency towards a healthier diet is continuing to gain ground and is significantly modifying the modes of consumption and purchasing habits. Consuming less sugar while continuing to take pleasure in eating is the ever-increasing desire of consumers in response to the numerous nutritional recommendations.

Furthermore, sugar-free products are particularly advantageous for the manufacture of confectioneries that have a therapeutic purpose, for example cough sweets or sweets for the airways, etc.

Hard coating is a unit operation employed in a good number of fields and especially in confectionery or in pharmacy. It may also concern the additives industry such as flavourings, sweeteners, vitamins, enzymes, acids and plant-based products. This operation consists in creating a hard coating on the surface of solid or pulverulent products, in order to protect them for various reasons or alternatively in order to make them visually or gustatorily attractive.

Hard coating is directed towards obtaining a sweet crunchy layer, which is always highly appreciated by consumers.

The coating of the centre is performed in a drum rotating about its axis, known as a coating pan, inside which is a plurality of centres forming a mass in motion, at the surface of which is distributed in liquid form the material constituting the future envelope.

Hard coating always requires the use of a syrup containing crystallizable materials. The hard, crystalline coating is obtained by applying this syrup and evaporating off the water thereby introduced.

The term “hard coating” employed in the present invention will also include very similar techniques, such as glazing and frosting. Glazing consists of one or two applications or charges of a crystallizable syrup that is dilute relative to the syrup used in hard coating. The aim is often to improve the surface appearance of sweet-coated products. Hard coating is often followed by glazing. Frosting contributes to modify the visual appearance of products, but also towards isolating these products from atmospheric moisture. This technique resembles hard coating. The essential difference lies in the fact that the number of coating cycles performed is only one, two or three.

Coating is a long and laborious process, including a large number of successive steps. Each of these steps, also known as a coating cycle, typically includes a phase of application, generally by spraying, of a coating syrup (containing one or more polyols, such as for example mix of xylitol and mannitol or mix of sorbitol and erythritol or mix of maltitol and erythritol as described in the previous art, but also occasionally binders such as gum arabic or gelatin, colourants such as TiO₂, intense sweeteners, etc.) onto the centres, a rotary phase for distributing the said syrup over the centres, also known as a pause time, and a phase of drying of each new coated syrup, performed by blowing with hot, dry air. This succession of cycles must be repeated a very large number of times, of the order of 10 to 24 times, so as to obtain the desired degree of enlargement. The degree of enlargement, also known as the final degree of coating, is defined by the increase in weight of the products. It is calculated by the weight ratio of the finished (sweet-coated) product to the weight of the centre or core before coating.

The process of the present invention is characterized in that it comprises a first step of hard coating characterized by a succession of repeating cycles always comprising a first step that consists in uniformly moistening the surface of the products in motion using the chosen coating syrup, a second step for uniformly distributing this syrup on the surface of the products (pause time or rotary time), and finally a third step of drying by blowing with hot, dry air, which evaporates the water introduced by the syrup and thus brings about crystallization of the applied polyol, before the application of the following layer performed by carrying out a new cycle.

According to one preferred embodiment, the hard coating of the said process is characterized by a succession of several repeating cycles of spraying, distribution and drying.

According to an even more preferential embodiment, the hard coating step for creating a hard coating on the surface of a centre comprises between 5 and 30 successive cycles, each cycle consisting of a phase of spraying a coating syrup, a phase of distributing the said syrup and a drying phase.

In one embodiment of the invention, the coating syrup, also known as the coating syrup, is a syrup containing polyols.

In the present invention, the term “polyols” denotes products obtained by catalytic hydrogenation of simple reducing sugars thus having a DP equal to 1 (DP=degree of polymerization), but also more complex reducing sugars composed of higher homologues with a DP greater than or equal to 2 of these simple sugars, such as disaccharides, oligosaccharides and polysaccharides, and also mixtures thereof. Generally, the simple reducing sugars intended for catalytic hydrogenation to obtain polyol compositions such as those of the invention are glucose, xylose, fructose and mannose. The polyols obtained are then sorbitol, xylitol and mannitol. The disaccharides are usually maltose, maltulose, isomaltulose and lactose, which lead, by hydrogenation, to maltitol, isomalt, isomaltitol and lactitol. The oligosaccharides and polysaccharides, which are products of higher molecular weight, are typically derived from an acidic and/or enzymatic hydrolysis of starches and/or feculents, of xylans or fructans such as inulin, but may also be obtained by acidic and/or enzymatic recombination of monosaccharides or disaccharides such as those mentioned above.

Consequently, the coating syrup used in the process of the present invention is a syrup containing polyols chosen especially from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM) and alpha-D-glucopyranosyl-1,1-sorbitol (=1,1-GPS), and mixtures thereof.

According to one preferential embodiment, the process of the present invention is characterized in that the polyol contained in the coating syrup is predominantly maltitol, for instance at least 50, 60, 70, 80 or 90% in weight of maltitol.

The process of the present invention is characterized in that the polyol syrup used in the hard coating phase is a syrup composed, relative to its content of soluble dry matter, of at least 80% by weight of a polyol.

Use will preferably be made of a coating syrup with a polyol richness of at least 80% by weight on a dry basis, preferably at least 85%, more preferentially at least 90% and even more preferentially at least 92%.

The coating syrup may be prepared from all polyols marketed by the Applicant in powder form under the brand names SweetPearl® for maltitol and ISOMALTISORB® for hydrogenated isomaltulose. Use may also be made of ready-to-use syrups, for instance maltitol syrups with a high maltitol content.

The solids content of the coating syrup is between 60% and 90%, more preferably between 70% and 85% and even more preferentially greater than or equal to 72% and less than 80%.

The syrup used is brought to a temperature below 100° C. before application. In one advantageous embodiment, the temperature of the syrup is between 40° C. and 95° C. and even more advantageously between 60° C. and 80° C. His applied, for example, by spraying.

The coating cycle according to the present invention comprises at least one drying step comprising the use of air at a temperature of between 15° C. and 70° C. and preferably between 25° C. and 50° C., for a time of at least 1 minute and of not more than 5 minutes.

Outside these “hot” phases, the temperature prevailing in the moving bed of centres to be coated is maintained throughout the majority of the coating process at a temperature of between 10° C. and 50° C. and preferably between 15 and 40° C.

It is also obvious that the drier the air blown into the turbine, the faster will be the process.

The desired degree of enlargement may be freely chosen as a function of the nature of the centre to be sweet-coated or of the desired effects.

According to one particular embodiment of the present invention, degrees of enlargement of greater than 25% are obtained.

According to one particular embodiment of the invention, additives such as colourants, intense sweeteners or flavourings may be added to the polyol syrup to be sprayed. It is also possible to envisage incorporating binders such as vegetable gums, carboxymethylcellulose and gelatin, modified starches and feculents (from pea, corn, wheat, potato, tapioca, rice, etc.), maltodextrins, dextrins such as NUTRIOSE® resistant maltodextrins such as FIBERSOL®, polydextrose, maltitol syrups such as LYCASIN® HBC, and fatty substances such as monoglycerides and diglycerides.

Another particular embodiment of the invention may envisage the mixing of various polyols in the coating syrup and/or in the filler.

According to one particularly advantageous embodiment of the invention, the coating syrup may also contain pigments such as calcium carbonate, titanium dioxide or a food colourant, and also intense sweeteners such as aspartame, acesulfame K, saccharin, sucralose, alitame, neotame, neohesperidin, thaumanine, sodium or calcium cyclamate, brazzein derivatives and steviosides.

Another variant of the invention consists in adding to the coating syrups or to the polyol powder fillers such as talc, calcium carbonate, aluminium or magnesium silicates, Ca, Mg, Na, Zn, Fe, P or Li salts, etc.

According to the invention, the products to be sweet-coated are subjected to turbining, i.e. to a rotational motion in a coating turbine. This turbine may have an ordinary shape, i.e. tulip-shaped with an inclined axis of revolution, or alternatively a cylindrical shape with a horizontal axis. The centres have a spherical, cylindrical or oval shape in order to facilitate the coating operation, but may also have a cushion or pellet shape. These conventional centres, which are low in sugar or sugar-free, may contain a liquid, pasty or pulverulent filling.

The process of the present invention is characterized in that it comprises a second step of “fatty coating” characterized by the application of a fatty layer to the layer obtained after the preliminary hard coating step, described previously.

According to the present invention, the second step of “fatty coating” is characterized in that it comprises at least one cycle always comprising a first step of spraying an oil or a melted fat onto the surface of the centres, a second step known as the pause time or rotary phase for uniformly distributing the oil or the melted fat onto the surface of the centres, and finally a third step of drying by blowing with hot, dry air which is intended to harden or congeal the oil or the melted fat layer before the application of the following layer.

According to one preferential embodiment, the fatty coating step comprises between 1 and 5 successive cycles.

According to another preferred embodiment, the process according to the invention characterized in that the fatty coating step comprises between 1 and 5 successive cycles, each cycle consisting of a phase of spraying an oil or a melted fat onto the surface of the centres, a phase of distributing the oil or the melted fat and a hardening phase. According to one preferred mode, the fatty coating step comprises a single cycle of spraying, distribution and hardening of the oil or the melted fat.

In the present invention, the oil or the melted fat intended for the fatty coating is chosen from melted cocoa butter, cocoa liquor, condensed milk, hydrogenated vegetable oils, hydrogenated palm seed oil, lauric oil, palm oil, soybean oil, cottonseed oil, linseed oil, coconut oil and any other vegetable oil that may be used in food, artificial butter, animal fats (butter, lard, . . . ), and also all mixtures of one or more of these oils and/or melted fats.

According to one preferred embodiment, the fatty coating is performed using melted fat.

According to one other preferred embodiment, the oil or melted fat used belongs to the category of CBS or cocoa butter substitutes. CBSs are vegetable fats derived from palm oil and from shea butter, which are chemically and physically very similar to cocoa butter.

Once the fatty coating has been performed, an optional step of dusting with a polyol powder, also known as a filler, may be applied to the centres, in order to prepare them for the next hard coating step.

This also makes it possible to prevent the surface of the centre from becoming too tacky or pasty after the fatty coating.

One variant of the process according to the invention thus consists in adding, after application of the oil or the melted fat during the fatty coating step, a polyol powder (typically by dusting), of high purity, preferably greater than 95% by weight.

According to one preferential embodiment, the said powder has a purity of greater than 98% and preferably greater than 99%.

According to one embodiment, the polyol of the said powder is chosen especially from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM) and alpha-D-glucopyranosyl-1,1-sorbitol (=1,1-GPS), and mixtures thereof.

As regards the polyol powder, it is preferable to use fine powders, containing less than 60% of particles with a diameter of greater than 250 microns.

According to one particular embodiment of the process, the coating syrups applied during the hard coating phase may be prepared from the polyol powder applied during this optional step.

According to another particular embodiment of the process, the said polyol powder and the said coating syrup have a polyol “in common”, i.e. the said powder and the said syrup contain a common polyol ingredient.

In one particularly advantageous embodiment of the invention, the process may also comprise a preliminary phase of precoating intended to create around the centres a first hard but thin coat, which is intended solely to initiate the actual coating step.

This precoating step is characterized by the application of a coating syrup containing polyols, followed by a pause time or rotary phase for uniformly distributing the syrup onto the surface of the centres, followed by a step of dusting with a polyol powder directly onto the syrup, followed by a further pause step before the final drying step. This first precoating step for producing a first thin and crunchy sub-layer on the surface of the centres is an optional step which is performed mainly as a function of the nature of the centres to be sweet-coated. This precoating step comprises between 1 and 10 cycles as described above.

In the present invention, the precoating step may be likened to a gumming step that consists in attaching to the centres a layer of adhesive substances that will enable better attachment of the coating layers during the enlargement or coating step.

The process of the present invention always comprises at least one hard coating phase, itself comprising from 5 to 30 successive cycles followed by a fatty coating phase comprising from 1 to 5 successive cycles.

In one preferred embodiment, the process according to the present invention is characterized in that it comprises a hard coating phase, a fatty coating phase, a new hard coating phase, a new fatty coating phase and a third and final hard coating phase.

The invention relates to a process for preparing confectioneries which enables the creation of a hard laminated coating on the surface of a centre, and comprising a plurality of cycles each comprising the following steps:
(a) an optional precoating step also known as a gumming step,
(b) a hard coating step comprising a first step of applying a coating syrup containing at least one polyol, the said polyol being obtained by catalytic hydrogenation of simple reducing sugers thus having a DP equal to 1, but also more complex reducing sugars composed of higher homologues with a DP greater than or equal to 2 of these simple sugars, such as disaccharides, oligosaccharides and polysaccharides and also mixtures thereof, and the said coating syrup having a solids content of between 60% and 90% by weight and preferably between 70% and 85% by weight, and even more preferentially greater than or equal to 72% and less than 80%; a second step for uniformly distributing this syrup on the surface of the products (pause time or rotary phase), and a third and final step of drying comprising the use of air at a temperature of between 40° C. and 80° C., for a time of at least 1 minute and of not more than 5 minutes;
(c) a step of coating in an oil phase comprising a step of applying an oil or a melted fat performed by spraying a liquid oil or a melted fat onto the surface of the centres, followed by a pause time or rotary phase for uniformly distributing the oil or the melted fat onto the surface of the centres, and completed with a drying step for fully hardening or congealing the oil or the melted fat layer before applying the following layer;

(d) an optional step of dusting with a polyol powder, also known as a filler.

A particularly preferred process of the present invention consists in performing steps a, b, c, d, b, c and b. That is to say that the process comprises three steps of hard coating and two steps of oil-phase coating and ends with a hard coating step.

The succession of these various coating phases involving either an aqueous polyol syrup or a liquid oil or a melted fat is a truly outstanding technical feat that the Applicant has succeeded in accomplishing. The reason for this is that it appeared entirely impossible to imagine producing on the surface of a centre a succession of different layers of different and opposing nature, by overcoming all the problems traditionally encountered: problems of sticking-together of the centres, problems of lack of uniformity in the distribution of the phases, problems of cracking, problems of attachment of the layers to each other.

According to one preferred mode of the invention, the said process is always completed with a hard coating step.

The process of the present invention combines all the following advantages:
that of preparing novel sugar-free confectioneries having a laminated structure composed of polyol and oil or melted fat,
that of being very rapid and of consequently affording considerable savings in time and thus large gains in productivity,
that of being easy to implement industrially,
that of being readily reproducible over time,
that of enabling the preparation of laminated sweet-coated confectioneries of very high quality, which are not tacky and which do not significantly change in appearance or texture over time.

The invention also relates to the confectioneries obtained by performing the said process.

These confectioneries are characterized in that they consist of an edible centre coated with a succession of layers obtained by the alternation of hard coating and oily coating steps.

The alternation and succession of aqueous layers and of fatty layers, several times, makes it possible to obtain a novel, laminated, creamy texture, while at the same time also maintaining a crunchy aspect imparted by the standard coating layer.

According to another preferential embodiment, the confectioneries obtained by performing the preparation process of the present invention may in addition, when this is possible, be filled with liquid, pasty, solid, powder, etc. fillings.

According to another more preferential embodiment, the confectioneries obtained by performing the preparation process of the present invention are sugar-free confectioneries.

According to another more preferential embodiment, the confectioneries of the present invention are sugar-free confectioneries, prepared from polyols, from a mixture of polyols, from a mixture of polyols and of soluble fibres, from mixtures of polyols, soluble fibres and proteins, and are particularly suitable for the present invention on account of their harmlessness towards the teeth and of their reduced calorific content when compared with sucrose.

According to one variant of the invention, the confectioneries of the present invention may be film-coated. Film coating consists in applying a film-forming liquid composition which, after drying, becomes a protective film. This film coating serves, for example, to protect the active principles contained in the confectionery and to protect the confectionery itself against moisture, impacts or brittleness, and also to give confectioneries attractive visual properties: gloss, a uniform colour, a smooth surface, etc.

According to a more preferential variant, the compositions used for the film coating are those described in patent application WO 2005/060 944, of which the Applicant is the proprietor.

The process in accordance with the invention makes it possible to coat all types of products, especially such as food products.

Thus, the confectioneries of the present invention are characterized in that the centre is chosen from confectioneries, chewing gums, bubble gums, tablets, lozenges, gelled articles, fruit jellies, chewing pastes, boiled sweets, chocolate-flavoured products, nuts such as almonds, hazelnuts or peanuts, pharmaceutical or veterinary products such as pills, tablets, animal products, dietary products such as plant granules, additives based on enzymes or microorganisms such as yeasts, detergent lozenges, vitamins, flavourings, fragrances, acids, sweeteners or various active principles.

In one preferred embodiment of the invention, the centres to be coated consist of sugar-free centres such as fruit jellies.

The invention will be understood more clearly with the aid of the examples that follow, which are intended to be illustrative but not limiting.

### Example 1

### Process for Manufacturing Novel Confectioneries According to the Invention

1. Centres

Some sugar free jellies were used as centres for the new confectioneries (400 g)

2. Step 1: Precoating

This step of precoating is optional. It is like a preliminary phase of precoating intended to create around the centres a first hard but thin coat, which is intended solely to initiate the actual coating step.

This precoating step is characterized by the application of a coating syrup containing polyol, followed by a pause time or rotary phase for uniformly distributing the syrup onto the surface of the centres, followed by a step of dusting with a polyol powder directly onto the syrup, followed by a further pause step before the final drying step. This first precoating step for producing a first thin and crunchy sub-layer on the surface of the centres is an optional step which is performed mainly as a function of the nature of the centres to be sweet-coated. This precoating step comprises between 1 and 10 cycles as described above.

The precoating syrup is prepared by dissolving a precoating powder, i.e. polyol powder in water. In the majority of the case, the precoating powder is Maltitol SweetPearl P200.

Precoating Syrup Recipe

| Ingredients | Concentration |
|---|---|
| Precoating powder | 50.00% |
| Water | 50.00% |
| Total | 100% |

Preparation of the Precoating Syrup
Dissolve precoating powder in water
Mix

Coating
Spray the precoating syrup on the centres rotating in the coating pan (7.5 to 9.5 g syrup per kg of centres)
Allow to distribute for 15 to 30 seconds
Dust the precoating powder on the centres
Allow to distribute for 15 to 30 seconds
Dry with air for 1 to 2 minutes

| Cycle | 1 | 2 | 3 | 4 | 5 | 6 |
|---|---|---|---|---|---|---|
| Syrup (g) | 3 | 3 | 3.2 | 3.5 | 3.5 | 3.8 |
| 1^{st} Pause time (min) | 0.5 | 0.5 | 0.5 | 0.5 | 0.5 | 0.5 |
| Precoating powder (g) | 5 | 5 | 5 | 6 | 6.5 | 0 |
| 2^{nd} Pause time (min) | 0.25 | 0.25 | 0.25 | 0.25 | 0.25 | 0.25 |
| Drying air direction | D | D | D | D | D | D |
| (D: direct) | | | | | | |
| Drying time (min) | 1 | 1 | 1.5 | 1.8 | 1.8 | 2 |

3. Step 2: First Layer Hard Coating

Coating Syrup Recipe

| Ingredients | Concentration | Dry Matter | D/D |
|---|---|---|---|
| Maltitol SweetPearl P200 | 66.29% | 66.29% | 94.70% |
| Gum arabic 40% | 8.75% | 3.50% | 5.00% |
| TiO₂ | 0.21% | 0.21% | 0.30% |
| Water | 24.75% | 0.00% | 0.00% |
| Total | 100% | 70.00% | 100.00% |

Preparation of Coating Syrup
Dissolve maltitol SweetPearl P200 powder in water by heating to about 90° C.
Cool down to below 70° C. and add gum arabic solution and titanium dioxide
Mix
Process the syrup at a temperature of 45-55° C.

Coating
Spray the syrup on the centres rotating in the coating pan (7.5 to 14.5 g syrup per kg of centres)
Allow to distribute for 30 to 60 seconds
Dry with air for 1 to 3 minutes

| Cycle | 1 | 2 | 3 | 4 | 5 | 6 | 7 | 8 | 9 | 10 |
|---|---|---|---|---|---|---|---|---|---|---|
| Syrup (g) | 3 | 3.6 | 3.4 | 3.6 | 4.1 | 4.4 | 5 | 4.8 | 5.4 | 5.8 |
| Pause time (min) | 1 | 1 | 1 | 1 | 1 | 1 | 1 | 1 | 1 | 1 |
| Drying air direction | D | D | D | D | D | D | D | D | D | D |
| (D: direct) | | | | | | | | | | |
| Drying time (min) | 1.2 | 1.2 | 1.2 | 1.2 | 1.5 | 1.5 | 1.5 | 2 | 3 | 3 |

| Cycle | 11 | 12 | 13 | 14 | 15 | 16 | 17 | 18 |
|---|---|---|---|---|---|---|---|---|
| Syrup (g) | 5.3 | 5.4 | 5.3 | 5 | 5 | 4.6 | 4.8 | 4.8 |
| Pause time (min) | 1 | 1 | 1 | 1 | 1 | 1 | 1 | 1 |
| Drying air direction | D | D | D | D | D | D | D | D |
| (D: direct) | | | | | | | | |
| Drying time (min) | 3 | 3 | 3 | 2 | 2 | 2 | 2 | 2 |

4. Step 3: First layer oil coating

Oil Type-Cocoa Butter Substitute (CBS)

Preparation of Oil
Melt CBS at about 50° C. to liquid phase
Process the liquid oil at a temperature of 30-35° C.

Coating
Introduce 34.15 g liquid oil on the centres rotating in the coating pan slowly
Allow to distribute for 1 to 2 minutes
Blow with cold air (below 16° C.) until the liquid fat transfers to solid phase
Dust 25.32 g of maltitol SweetPearl P35 powder on the centre surface rotating in pan.

5. Step 4: Second Layer Hard Coating

Coating Syrup Recipe

| Ingredients | Concentration | Dry Matter | D/D |
|---|---|---|---|
| SweetPearl P200 | 66.29% | 66.29% | 94.70% |
| Gum arabic 40% | 8.75% | 3.50% | 5.00% |
| TiO₂ | 0.21% | 0.21% | 0.30% |
| Water | 24.75% | 0.00% | 0.00% |
| Total | 100% | 70.00% | 100.00% |

Preparation of Coating Syrup
Dissolve maltitol SweetPearl P200 powder in water by heating to about 90° C.
Cool down to below 70° C. and add gum arabic solution and titanium dioxide
Mix
Process the syrup at a temperature of 45-55° C.

Coating
Spray the syrup on the centres rotating in the coating pan (9.5 to 21.5 g syrup per kg of centres)
Allow to distribute for 30 to 60 seconds
Dry with cold air for 2 to 3 minutes
Repeat this operation until the required weight is obtained

| Cycle | 19 | 20 | 21 | 22 | 23 | 24 | 25 | 26 | 27 | 28 |
|---|---|---|---|---|---|---|---|---|---|---|
| Syrup (g) | 3.85 | 4 | 4.4 | 5 | 7.7 | 7 | 7 | 7 | 6.37 | 5 |
| Powdering | ≈20 | ≈20 | 0 | 0 | 0 | 0 | 0 | 0 | 0 | 0 |
| Pause time (min) | 1.5 | 1.5 | 1.5 | 1.5 | 1.5 | 1.5 | 1.5 | 1.5 | 1.5 | 1.5 |
| Drying air direction | D | D | D | D | D | D | D | D | D | D |
| (D: direct) | | | | | | | | | | |
| Drying time (min) | 2 | 2 | 2 | 2 | 3 | 3 | 3 | 3 | 3 | 2 |
| Syrup | cold | cold | cold | cold | cold | cold | cold | cold | cold | cold |

| Cycle | 29 | 30 | 31 | 32 | 33 | 34 | 35 |
|---|---|---|---|---|---|---|---|
| Syrup (g) | 5 | 6 | 6.3 | 6 | 8.5 | 5.5 | 6.5 |
| Powdering | 0 | 0 | 0 | 0 | 0 | 0 | 0 |
| Pause time (min) | 1.5 | 1.5 | 1.5 | 1.5 | 1.5 | 1.5 | 1.5 |
| Drying air direction | D | D | D | D | D | D | D |
| (D: direct) | | | | | | | |
| Drying time (min) | 2 | 2 | 2 | 2 | 3 | 2 | 2 |

Note: First 8-10 cycles hard coating after oil coating, the syrup must be cold, because if we dropped hot syrup, the solid phase fat may melt to liquid which will introduce a rough surface on the coated centres.

6. Step 5: Second Layer Oil Coating

Oil Type-Cocoa Butter Substitute (CBS)

Preparation of Oil
Melt CBS at about 50° C. to liquid phase
Process the liquid oil at a temperature of 30-35° C.

Coating
Introduce 70 g liquid oil on the centres rotating in the coating pan slowly
Allow to distribute for 1 to 2 minutes
Blow with cold air (below 16° C.) until the liquid fat transfers to solid phase
Dust 35 g maltitol SweetPearl P35 powder on the centre surface rotating in pan.

7. Step 6: Third Layer Hard Coating

Coating Syrup Recipe

| Ingredients | Concentration | Dry Matter | D/D |
|---|---|---|---|
| Maltitol SweetPearl P200 | 66.29% | 66.29% | 94.70% |
| Gum arabic 40% | 8.75% | 3.50% | 5.00% |
| TiO₂ | 0.21% | 0.21% | 0.30% |
| Water | 24.75% | 0.00% | 0.00% |
| Total | 100% | 70.00% | 100.00% |

Preparation of Coating Syrup
Dissolve SweetPearl P200 powder in water by heating to about 90° C.
Cool down to below 70° C. and add gum arabic solution and titanium dioxide
Mix
Process the syrup at a temperature of 45-55° C.

Coating
Spray the syrup on the centres rotating in the coating pan (10 to 13.5 g syrup per kg of centres)
Allow to distribute for 60 seconds
Dry with cold air for 2 to 3 minutes
Repeat this operation until the required weight is obtained

| Cycle | 36 | 37 | 38 | 39 | 40 | 41 | 42 | 43 | 44 | 45 |
|---|---|---|---|---|---|---|---|---|---|---|
| Syrup (g) | 4 | 4.96 | 5.1 | 5.2 | 5.2 | 5.2 | 5.3 | 5.4 | 5.3 | 5.12 |
| Pause time (min) | 1 | 1 | 1 | 1 | 1 | 1 | 1 | 1 | 1 | 1 |
| Drying air direction | D | D | D | D | D | D | D | D | D | D |
| (D: direct) | | | | | | | | | | |
| Drying time (min) | 2 | 2 | 2 | 2 | 3 | 3 | 3 | 3 | 3 | 2 |
| Syrup | cold | cold | cold | cold | cold | cold | cold | cold | cold | |

| Cycle | 46 | 47 | 48 | 49 | 50 | 51 | 52 |
|---|---|---|---|---|---|---|---|
| Syrup (g) | 5.2 | 5 | 5.1 | 5 | 4.9 | 5.1 | 5.1 |
| Pause time (min) | 1 | 1 | 1 | 1 | 1 | 1 | 1 |
| Drying air direction | D | D | D | D | D | D | D |
| (D: direct) | | | | | | | |
| Drying time (min) | 3 | 3 | 3 | 3 | 2 | 3 | 3 |

Note: First 8-10 cycles hard coating after oil coating, the syrup must be cold, because if we dropped hot syrup, the solid phase fat may melt to liquid which will introduce a rough surface on the coated centres.

1-15. (canceled)

16. A process for preparing a confectionery, comprising creating around an edible centre a succession of at least two coating layers by alternating an aqueous layer hard coating comprising a coating syrup and an oily layer comprising fat and/or melted fat.

17. The process according to claim 16, wherein the hard coating is a sugar-free hard coating.

18. The process according to claim 16, wherein the step for creating a hard coating on the surface of the edible centre comprises between 5 and 30 successive cycles, each cycle comprising a phase of spraying a coating syrup, a phase of distributing the coating syrup and a drying phase.

19. The process according to claim 16, wherein the coating syrup contains polyols selected from the group consisting of sorbitol, xylitol, erythritol, maltitol, isomalt, isomaltitol, lactitol, alpha-D-glucopyranosyl-1,6-sorbitol (1,6-GPS), alpha-D-glucopyranosyl-1,1-mannitol (1,1-GPM) and alpha-D-glucopyranosyl-1,1-sorbitol (1,1-GPS), and mixtures thereof.

20. The process according to claim 19, wherein the polyol contained in the coating syrup is predominantly maltitol.

21. The process according to claim 19, wherein the polyol syrup used in the hard coating phase is a syrup composed, relative to its content of soluble solids, of at least 80% by weight of a polyol.

22. The process according to claim 16, wherein the oily layer coating step comprises between 1 and 5 successive cycles, each cycle comprising a phase of spraying an oil or a melted fat onto the surface of the centres, a phase of distributing the oil or the melted fat and a hardening phase.

23. The process according to claim 16, wherein the oil or the melted fat is selected from the group consisting of melted cocoa butter, cocoa liquor, condensed milk, hydrogenated vegetable oil, hydrogenated palm seed oil, lauric oil, palm oil, soybean oil, cottonseed oil, linseed oil, coconut oil, vegetable oil, artificial butter, animal fat and mixtures of one or more of these oils and/or melted fats.

24. The process according to claim 23, wherein the oil or melted fat is a cocoa butter substitute (CBS).

25. The process according to claim 16, said process comprising:
(a) an optional precoating step (gumming step),
(b) a hard coating step, comprising a first step of applying a coating syrup containing at least one polyol, the said polyol being obtained by catalytic hydrogenation of simple reducing sugars, thus having a degree of polymerization (DP) equal to 1, and more complex reducing sugars composed of higher homologues with a DP greater than or equal to 2 of these simple sugars, said coating syrup having a solids content of between 60% and 90% by weight; a second step of uniformly distributing this syrup on the surface of the products, and a third and final step of drying, comprising the use of air at a temperature of between 40° C. and 80° C., for a time of at least 1 minute and not more than 5 minutes;
(c) a step of coating in an oil phase, comprising a step of applying an oil or a melted fat by spraying a liquid oil or a melted fat onto the surface of the centres, followed by a pause time or rotary phase for uniformly distributing the oil or the melted fat onto the surface of the centres, and completed with a drying step for fully hardening or congealing the oil of the melted fat layer before applying the following layer; and
(d) an optional step of dusting with a polyol powder.

26. The process according to claim 25, comprising the succession of steps a, b, c, b, c and b.

27. The process according to claim 25, wherein the final step is a step of hard coating.

28. Confectioneries produced by the process of claim 16.

29. The confectioneries according to claim 28, said confectioneries comprising an edible centre coated with a succession of layers obtained by the alternation of hard coating and oily coating steps.

30. The confectioneries according to claim 29, wherein the centre is chosen from confectioneries, chewing gums, bubble gums, tablets, lozenges, gelled articles, fruit jellies, chewing pastes, boiled sweets, chocolate-flavoured products, nuts, pharmaceutical or veterinary products, dietary products, detergent lozenges, vitamins, flavourings, fragrances, acids, sweeteners or various active principles.
